(19) United States
(12) Patent Application Publication
(10) Pub. No.: US 2010/0088966 A1
(43) Pub. Date: Apr. 15, 2010

(54) Container Door Structure

(75) Inventors: Jianjun He, Guangdong (CN); Youngpeng Zhou, Guangdong (CN)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: CHINA INTERNATIONAL MARINE CONTAINERS (GROUP) LTD.

(21) Appl. No.: 12/529,281

(22) PCT Filed: Mar. 3, 2008
(86) PCT No.: PCT/CN2008/000428

§ 371 Date: Aug. 31, 2009

(30) Foreign Application Priority Data
Mar. 2, 2007 (CN) 200710073433.X

(51) Int. Cl. E06B 7/16; E06B 3/70

(52) U.S. Cl. 49/475.1

(57) ABSTRACT

A door end structure of a container comprises an upper end beam, a lower end beam, a container door and a locking lever. The container door comprises an upper door beam, a lower door beam and a door panel which is a vertical corrugated plate. The locking lever is received in a trough of the vertical type door panel. The upper door beam comprises a web plate and an upper wing plate, and the lower door beam comprises a web plate and a lower wing plate. Both the inner side surface of the web plate of the upper door beam and the inner side surface of the web plate of the lower door beam are flush with the inner side surface of the door panel. A concave is provided at a lower corner outside the upper end beam, and the upper wing plate of the upper door beam is located in the concave and its bottom surface is at most flush with that of the upper end beam. A concave is provided at an upper corner outside the lower end beam, and the lower wing plate of the lower door beam is located in the concave and its top surface is at most flush with that of the lower end beam. A door seal tape is provided on the upper wing plate of the upper door beam and the lower wing plate of the lower door beam. Therefore, the space in the interior of the container can be efficiently increased without changing the external dimension of the container.

### FIELD OF THE INVENTION

The present invention relates to a container, particularly to a door end structure of the container.

### BACKGROUND OF THE INVENTION

Since 1960, a container, as a cargo carrier, has been developed into an international general multimodal transportation tool. In the field of container, a dry cargo container generally used by general cargoes has been applied widely due to its strong adaptability.

As shown in FIG. 1, FIG. 2 and FIG. 3, the generally used dry cargo container comprises a underframe 10, an upper end beam 11, a lower end beam 12, a corner post 13, a side plate 14 and a top plate 15, a container door 16 which is usually arranged at a rear end of the container, as for an application for loading special cargoes, may be arranged at a side of the container. In order to meet the requirement to an international transportation, the external dimension of the generally used dry cargo container and intensity of the main work conditions can be defined definitely in accordance with an international standard. Accordingly, if the dry cargo container having pre-determined external dimension intends to increase its storing space, it is necessary to improve the shape and the position of the structural components consisting of the internal space. The internal length and width of the dry cargo container are those of the largest rectangular hexahedron in the internal space thereof respectively. The internal length is calculated from the inner side surfaces of the container door to the inner side surfaces of the frontal wall panel on the basis of the industrial custom. Therefore, the internal length defines the storing space without changing the length and the height of the container interior.

As shown in FIG. 4, both an upper door beam 160 and a lower door beam 161 of the existing container door 16 have a “C” shaped structure, and meanwhile, a door panel 162 is a transverse type corrugated plate, i.e. ripples in the corrugated plate waves are arranged in a horizontal direction. When mounting a door locking device 17, troughs of the door panel 162 must be extended towards the interior of the container. Consequently, the length L from outer end surfaces 181 of an corner fittings 18 to innermost surfaces of the “C” shaped beam is a “useless length” which cannot be used to store cargoes. The length L includes the length occupied by the “C” shaped beam and the door locking device. Therefore, in the case that the external dimension of the container is determined, the “useless length” causes a limitation to the length of storing cargoes. There would have a great economical impact if such “useless length” can be reduced, i.e. the storing space can be increased.

### SUMMARY OF THE INVENTION

The technical problem to be solved by the present invention is to provide a door end structure of the container, which enables to increase the space of the interior of the container efficiently without changing the external dimension of the container, so as to solve the problem existed in the priority art.

The technical solution for solving the technical problem of the present invention is to configure a door end structure of the container, comprising a upper end beam, a lower end beam, a container door and a locking lever arranged outside the container door, the container door including an upper door beam, a lower door beam and a door panel connected therebetween, wherein the door panel is a vertical corrugated plate; the locking lever is received in a trough of the vertical type corrugated door panel; the upper door beam comprises a web plate and an upper wing plate extending towards the interior of the container from an upper end of the web plate, the lower door beam comprises a web plate and a lower wing plate extending towards the interior of the container from the lower end of the web plate; both the inner side surface of the web plate of the upper door beam and the inner side surface of the web plate of the lower door beam are flush with the inner side surface of the door panel; a concave for receiving the upper wing plate of the upper door beam is provided at a lower corner outside the upper end beam, the upper wing plate of the upper door beam is located in the concave of the upper end beam and its bottom surface is at most flush with the bottom surface of the upper end beam; a concave for receiving the lower wing plate of the lower door beam is provided at an upper corner outside the lower end beam, the lower wing plate of the lower door beam is located in the concave of the lower end beam and its upper surface is at most flush with the top surface of the lower end beam; and a door seal tape is provided on the upper wing plate of the upper door beam and the lower wing plate of the lower door beam.

According to the technical concept of the present invention, the upper door beam further comprises a lower wing plate extending towards the exterior of the container from the lower end of the web plate; the lower door beam further comprises an upper wing plate extending towards the exterior of the container from the upper end of the web plate; the door panel is a throughout corrugated plate throughout which ripples extend up and down; the top end and the bottom end of the door panel are welded to the lower wing plate of the upper door beam and the upper wing plate of the lower door beam respectively; and a recess for receiving the locking lever is provided at a point in the lower wing plate of the upper door beam and the upper wing plate of the lower door beam correspond to the locking lever respectively

According to the technical concept of the present invention, the door panel is a blind corrugated plate on which both ends of ripples are terminated inside the door panel; the top end and the bottom end of the door panel are welded to the end of the downward extended web plate of the upper door beam and the end of the upward extended web plate of the lower door beam respectively.

According to the technical concept of the present invention, the lower end beam comprises a main beam and a door seal beam located outside of and connected integrally to the main beam; the top surface of the door seal beam is lower than that of the main beam to form the concave of the lower end beam.

According to the technical concept of the present invention, the surface on which a crest of the vertical corrugated plate is arranged will not exceed the outer end surface of the corner fittings of the container close to the door end of the container.

Advantageous effects of applying the door end structure of the container according to the present invention are as follows: a specifically designed structure is applied into the upper door beam and the lower door beam, and their web plates are flush with the inner side surface of the corrugated plate of the door panel, such that the length of the interior of the contain can be increased without changing the volume of the container. Furthermore, a hidden treatment is conducted to the fitting parts of the upper door beam and the lower door beam with the upper end beam and the lower end beam, such that the height of the interior of the container can be increased without changing the external dimension of the container. As a result, the available capacity of the container can be increased to improve the carrying capacity of the single container. Besides, a vertical corrugated plate structure is provided in the door panel to receive the locking lever wherein, so as to reduce the length or width of the container taken by the locking lever itself.

### BRIEF DESCRIPTION OF DRAWINGS

The present invention will now be described with reference to the accompanying drawings and the embodiments, in which:

FIG. 1 is a perspective view of the container according to the priority art;

FIG. 2 is a top view of the container according to the priority art;

FIG. 3 is a sectional view in A-A direction of the container according to the priority art;

FIG. 4 is a schematic view showing the door end structure of the container according to the priority art;

FIG. 5 is a sectional view of the door end structure of the container according to the first embodiment of the present invention;

FIG. 6 is a cross sectional view of the door panel in the first embodiment of the present invention, showing the relationship between the door panel and the door lock;

FIG. 7 is a sectional view of the upper door beam in the first embodiment of the present invention;

FIG. 8 is a sectional view of the lower door beam in the first embodiment of the present invention;

FIG. 9 is a view in a direction indicated by the arrow B in FIG. 7, showing a hole on the lower wing plate of the upper door beam, through which the locking lever passes;

FIG. 10 is a schematic view showing the structure of another lower end beam; FIG. 11 is a sectional view of door end structure of the container according to the second embodiment of the present invention;

FIG. 12 is a view of door end structure of the container in a direction indicated by the arrow E in FIG. 11;

FIG. 13 is an enlarged view of part C in FIG. 11; and

FIG. 14 is an enlarged view of part D in FIG. 11.

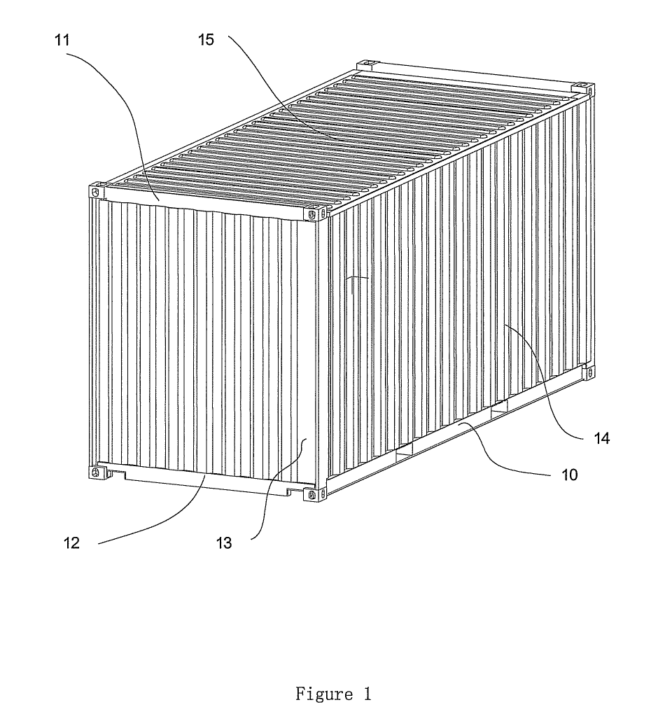

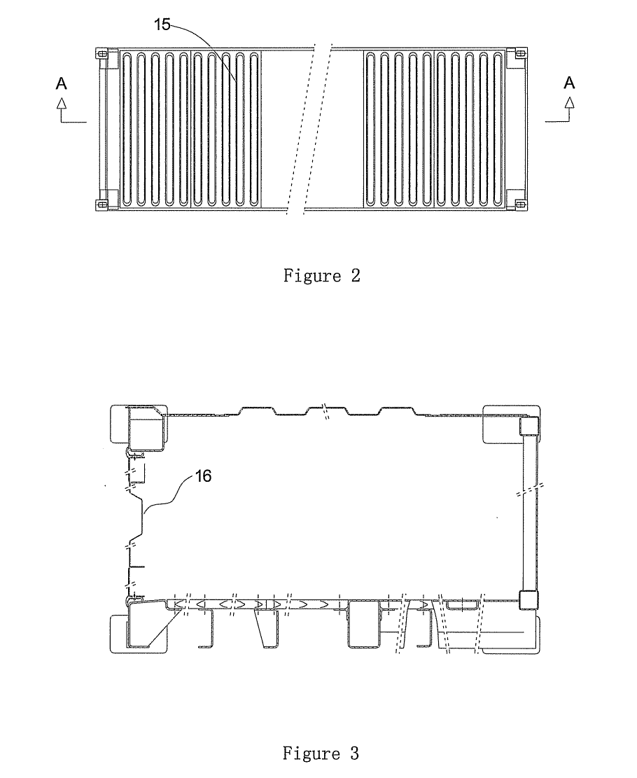

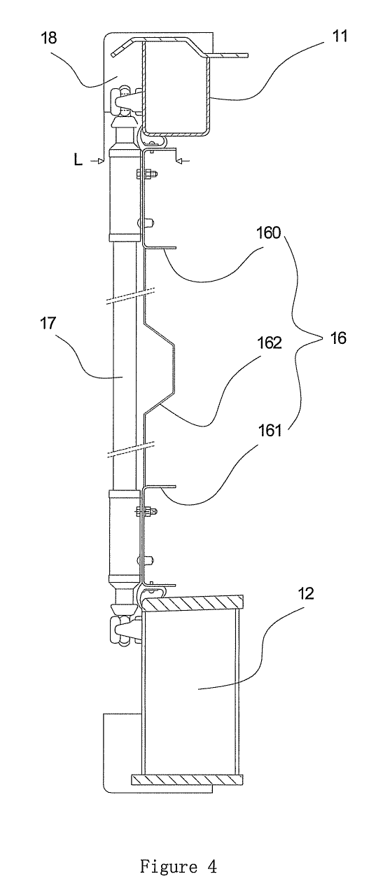

### DETAILED DESCRIPTION OF THE PREFERRED EMBODIMENTS

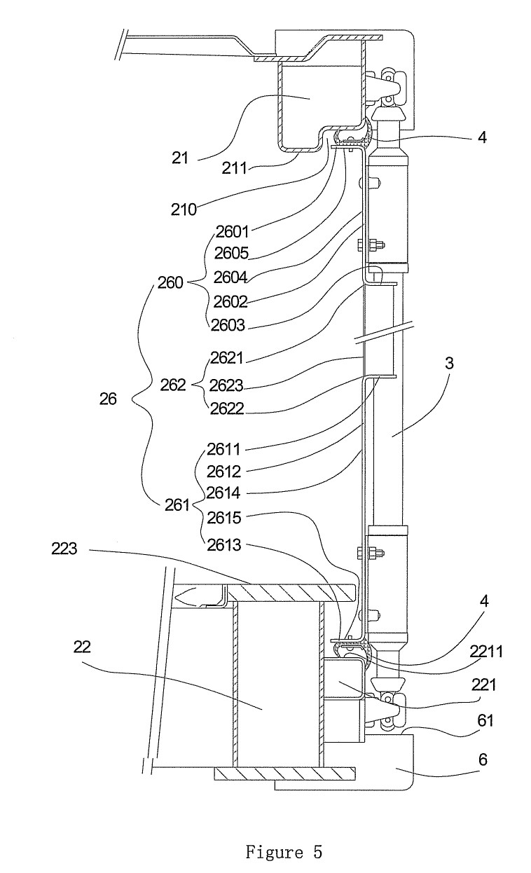

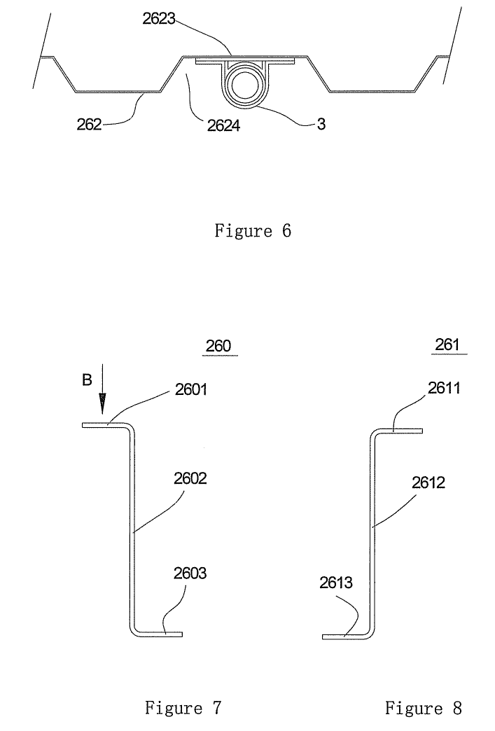

As shown in FIG. 5 and FIG. 6, the door end structure of the container according to the first embodiment of the present invention comprises an upper end beam 21, a lower end beam 22, a container door 26 therebetween, and a locking lever 3 located on the outside the container door 26, the container door 26 includes an upper door beam 260, a lower door beam 261, and a door panel 262 connected between the upper door beam 260 and the lower door beam 261.

As shown in FIG. 7 and FIG. 8, the upper door beam 260 includes an upper wing plate 2601, a lower wing plate 2603, and a web plate 2602 connected therebetween and being perpendicular to both the upper and the lower wing plate, the upper wing plate 2601 extends towards the interior of the container from an upper end of the web plate 2602, while the lower wing plate 2603 extends towards the exterior of the container from the lower end of the web plate 2602. The lower door beam 261 includes an upper wing plate 2611, a lower wing plate 2613, and a web plate 2612 connected therebetween and being perpendicular to both the upper and the lower wing plate, the upper wing plate 2611 extends towards the exterior of the container from the upper end of the web plate 2612, while the lower wing plate 2613 extends toward the interior of the container from the lower end of the web plate 2612.

A door panel 262 is a vertical-type corrugated plate, i.e. with the ripples arranged in vertical. A top end 2621 and a bottom end 2622 of the door panel 262 are welded to the upper door beam 260 and the lower door beam 261 respectively.

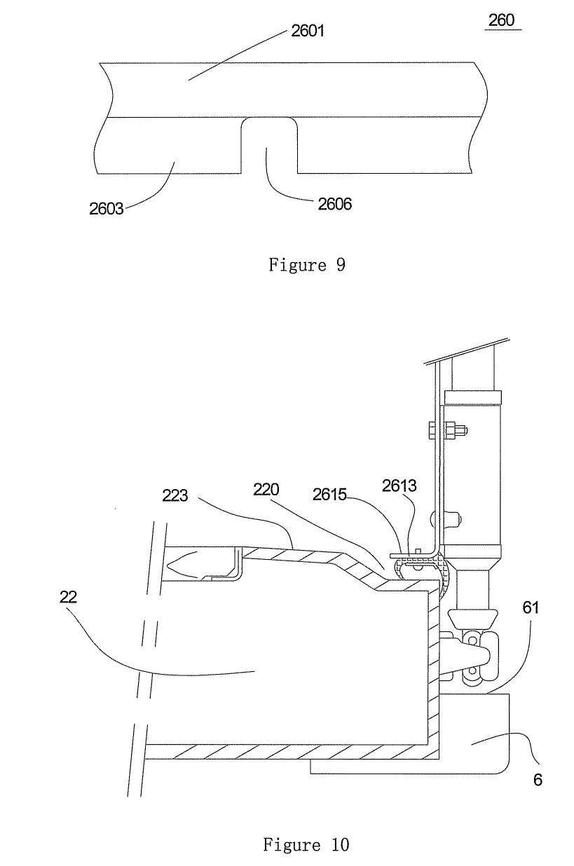

As shown in FIG. 5 and FIG. 6, the door panel 262 may be a run-through type corrugated plate, i.e. the ripples of the corrugated plate extended throughout the door panel 262 in a vertical direction. The top end 2621 of the door plate 262 is welded to the lower wing plate 2603 of the upper door beam 260, while the bottom end 2622 thereof is welded to the upper wing plate 2611 of the lower door beam 261. Both the inner side surface 2604 of the web plate 2602 of the upper door beam 260 and the inner side surface 2614 of the web plate 2612 of the lower door beam are flush with inner side surface 2623 of the door panel 262. The locking lever 3 is disposed in the trough 2624 of the door panel 262 towards the interior of the container, so as to reduce space taken by the locking lever 3 itself. As shown in FIG. 9, a recess 2606 for receiving the locking lever 3 is provided at a point in the lower wing plate 2603 of the upper door beam 260 corresponding to the locking lever 3. Similarly, a recess 2606 for receiving the locking lever 3 is also provided at a point in the upper wing plate 2611 of the lower door beam 261 corresponding to the locking lever 3. The locking lever 3 is connected to a lock seat (not shown) fixed on the upper end beam 21 and the lower end beam 22 through these recesses.

As shown in FIG. 5, a door seal tape 4 is provided on the upper wing plate 2601 of the upper door beam 260 and the lower wing plate 2613 of the lower door beam 261 respectively, to seal between the upper end beam 21 and the lower end beam 22 when the container door 26 is closed, so as to avoid dust and rain from entering.

In order to avoid the space of the interior of the container from being occupied by the upper wing plate 2601 of the upper door beam 260 to cause a limitation against the height of cargoes, a concave 210 for receiving the upper wing plate 2601 of the upper door beam 260 is provided at a lower corner of the upper end beam 21 towards the outside of the container. The upper wing plate 2601 of the upper door beam 260 is located inside of the concave 210, and its bottom surface 2605 is at most flush with the bottom surface 211 of the upper end beam 21. Of course, the recessed depth of the concave 210 may be relatively greater so that the upper wing plate 2601 of the upper door beam 260 is located inside the concave 210 in order to achieve the same purpose of keeping the bottom surface 2605 of the upper wing plate higher than the bottom surface 211 of the upper end beam 21. That is to say, the distance from the bottom surface 2605 of the upper wing plate 2601 of the upper door beam 260 to the upper surface 61 of the container underframe 6 is larger than or equal to that from the bottom surface 211 of the upper end beam 21 to the upper surface 61 of the container underframe 6, such that the space of the interior of the container can not be occupied by the upper wing plate 2601 of the upper door beam 260.

Similarly, the lower end beam 22 comprises a main beam 222 and a door seal beam 221 located outside of and welded integrally to the main beam 221, a top surface 2211 of the door seal beam 221 is lower than a top surface 223 of the main beam 222 to form a concave 220 of the lower end beam 22.

The top surface 2211 of the door seal beam 221 is fitted with the lower wing plate 2613 of the lower door beam 261 to ensure that the top surface of the lower wing plate 2613 of the lower door beam 261 is located lower than or at most flush with the top surface 223 of the lower end beam 22, so as to avoid the space inside the container from being occupied.

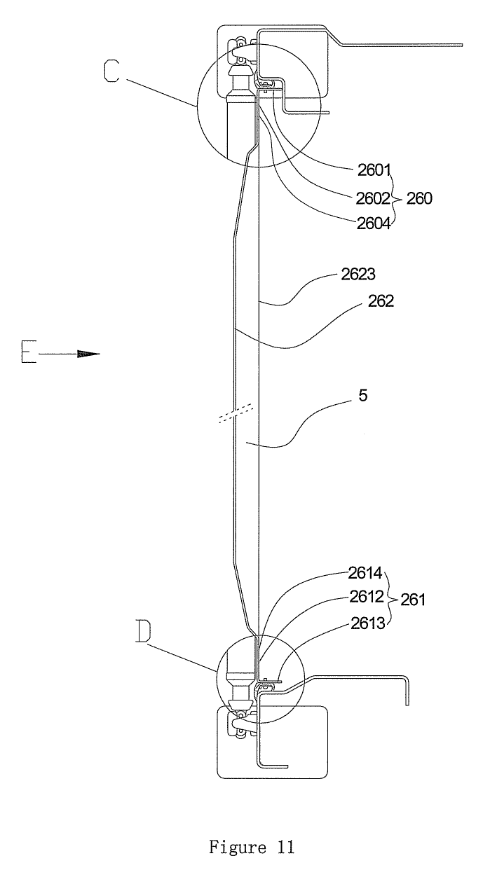

Obviously, the lower end beam 22 may have the similar structure with that of the upper end beam 21, as shown in FIG. 10, a concave 220 for receiving the lower wing plate 2613 of the lower door beam 261 is provided at an upper corner of the lower end beam 22 towards outside the container. The lower wing plate 2613 of the lower door beam 261 is located in the concave 220, and the top surface 2615 of the lower wing plate 2613 is flush with or lower than the top surface 223 of the lower end beam 22. That is, the distance from the top surface 2615 of the lower wing plate 2613 of the lower door beam 261 to the upper surface 61 of the container underframe 6 is larger than or equal to that from the top surface 223 of the lower end beam 22 to the upper surface 61 of the container underframe 6, so as to achieve the purpose of avoiding the space of the interior of the container from being occupied.

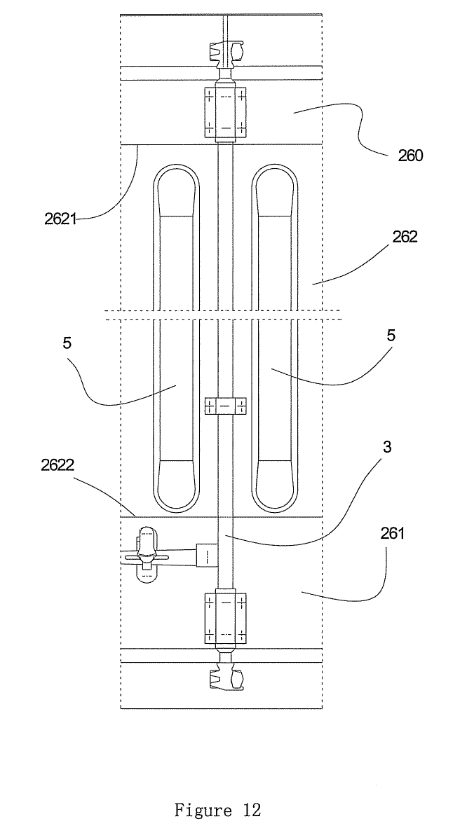

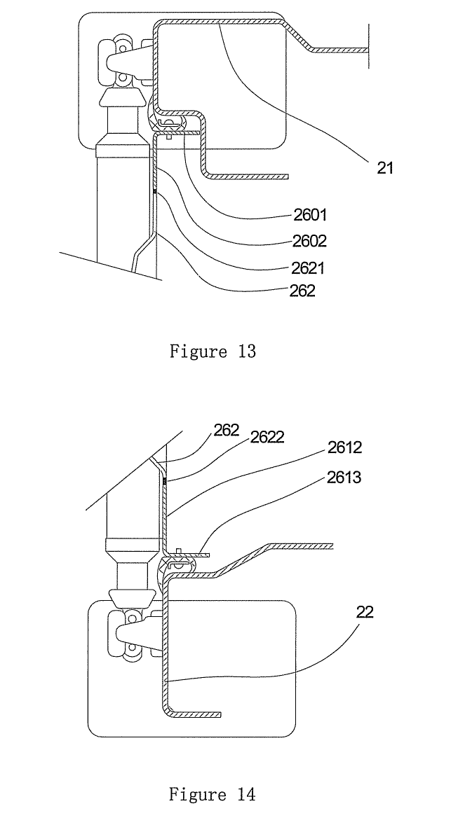

In door end structure of the container according to the second embodiment of the preset invention, as shown in FIG. 11 to FIG. 14, the upper door beam 260 may merely comprises an upper wing plate 2601 and a web plate 2602, and the upper wing plate 2601 extends towards the interior of the container from the upper end of the web plate 2602. Preferably, the upper wing plate 2601 is perpendicular to the web plate 2602. Similarly, the lower door beam 261 merely comprises the lower wing plate 2613 and the web plate 2612, and the lower wing plate 2613 extends towards the interior of the container from the lower end of the web plate 2612. Preferably, the lower wing plate 2613 is perpendicular to the web plate 2612. The door panel 262 may be the blind corrugated plate, i.e. with the ripples not extended throughout the door panel 262 in a vertical direction, in other words, the two ends of the ripples in the corrugated door panel 262 are terminated inside the door panel 262. As shown in FIG. 12, ripples 5 with two closed ends are arranged on the door panel 262. The top end 2621 of the door panel 262 is butt welded to the end of the downward extended web plate 2602 of the upper door beam 260, while the bottom end 2622 thereof is butt welded to the end of the extended downward web plate 2612 of the lower door beam 261, so as to be integrally formed. The ripples 5 protrudes towards the exterior of the container so as to form a trough towards the interior of the container between adjacent ripples 5, and a locking lever 3 is putted into the trough to reduce the space taken by the locking lever 3 itself. Hence, both the inner side surface 2604 of the web plate 2602 of the upper door beam 260 and the inner side surface 2614 of the web plate 2612 of the lower door beam 261 are flush with the inner side surface 2623 of the door panel 262.

The door end structure of the container according to the present invention may be provided at one end of the container or at a side of the container.

In order to keep the external dimension of the container according to the present invention unchanged, the surface on which the crest 2625 of the vertical corrugated plate 262 of the present invention are arranged will not exceed the outer end surface 181 of the corner fittings of the container close to the door end of the container, so as to ensure the external dimension of the contain unchanged.

As compared with the prior art, in the door end structure of the container according to the present invention, a specifically designed structure is applied into the upper door beam 260 and the lower door beam 261, and their web plates are flush with the inner side surface of the corrugated plate of the door panel, such that the length of the interior of the contain can be increased without changing the volume of the container. Furthermore, a hidden treatment is conducted to the fitting parts of the upper door beam 260 and the lower door beam 261 with the upper end beam 21 and the lower end beam 22, such that the height of the interior of the container can be increased without changing the external dimension of the container. As a result, the available capacity of the container can be increased to improve the carrying capacity of the single container. Besides, a vertical corrugated plate structure is provided in the door panel to receive the locking lever wherein, so as to reduce the length or width of the container taken by the locking lever itself.

The above descriptions are merely the preferable embodiments of the present invention but not to limit the protection scope of the present invention. It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A door end structure of a container comprising a upper end beam, a lower end beam, a container door and a locking lever arranged outside the container door, the container door including an upper door beam, a lower door beam and a door panel connected between the upper door beam and the lower door beam, wherein the door panel is a vertical corrugated plate; the locking lever is received in a trough of the vertical corrugated plate; the upper door beam comprises a web plate and an upper wing plate extending towards the interior of the container from an upper end of the web plate of the upper door beam, the lower door beam comprises a web plate and a lower wing plate extending towards the interior of the container from the lower end of the web plate of the lower door beam; both the inner side surface of the web plate of the upper door beam and the inner side surface of the web plate of the lower door beam are flush with the inner side surface of the door panel; a concave for receiving the upper wing plate of the upper door beam is provided at a lower corner outside the upper end beam, the upper wing plate of the upper door beam is located in the concave of the upper end beam and its bottom surface is at most flush with the bottom surface of the upper end beam; a concave for receiving the lower wing plate of the lower door beam is provided at an upper corner outside the lower end beam, the lower wing plate of the lower door beam is located in the concave of the lower end beam and its upper surface is at most flush with the top surface of the lower end beam; and a door seal tape is provided on the upper wing plate of the upper door beam and the lower wing plate of the lower door beam.

2. The door end structure of the container as claimed in claim 1, wherein the upper door beam further comprises a lower wing plate extending towards the exterior of the container from the lower end of the web plate of the upper door beam; the lower door beam further comprises an upper wing plate extending towards the exterior of the container from the upper end of the web plate of the lower door beam; the door panel is a throughout corrugated plate throughout which ripples extend up and down; the top end and the bottom end of the door panel are welded to the lower wing plate of the upper door beam and the upper wing plate of the lower door beam respectively; and a recess for receiving the locking lever is provided at a point in the lower wing plate of the upper door beam and the upper wing plate of the lower door beam corresponding to the locking lever respectively.

3. The door end structure of the container as claimed in claim 1, wherein the door panel is a blind corrugated plate on which both ends of ripples are terminated inside the door panel; the top end and the bottom end of the door panel are welded to the end of the downward extended web plate of the upper door beam and the end of the upward extended web plate of the lower door beam respectively.

4. The door end structure of the container as claimed in claim 1, wherein the lower end beam comprises a main beam and a door seal beam located outside of and connected integrally to the main beam; the top surface of the door seal beam is lower than that of the main beam to form the concave of the lower end beam.

5. The door end structure of the container as claimed in claim 1, wherein the surface on which a crest of the vertical corrugated plate is arranged does not exceed the outer end surface of the corner fittings of the container close to the door end of the container.
